(19) United States
(12) Patent Application Publication
(10) Pub. No.: US 2016/0292360 A1
(43) Pub. Date: Oct. 6, 2016

(54) METHOD AND SYSTEM FOR PATIENT IDENTIFICATION WHEN OBTAINING MEDICAL IMAGES

(71) Applicant: Algotec Systems Ltd., Ra'anana (IL)

(72) Inventors: Reuven R. Shreiber, Haifa (IL); Shaul S. Ben-Yossef, Givataim (IL)

(21) Appl. No.: 15/063,626

(22) Filed: Mar. 8, 2016

Related U.S. Application Data
(60) Provisional application No. 62/142,616, filed on Apr. 3, 2015.

(51) Int. Cl. G06F 19/00

(52) U.S. Cl. CPC G06F 19/321

(57) ABSTRACT

A system and method for patient identification when obtaining medical images. The method includes: identifying the patient according to a fixed identifier before medical imaging data is obtained; automatically selecting a medical imaging process according to the identifying the patient by a medical imaging process controller; performing the medical imaging process on the patient; and associating image data obtained from the performing the medical imaging process with a patient identity determined by the identifying the patient.

### CROSS REFERENCE TO RELATED APPLICATIONS

This application claims the benefit of U.S. Provisional application U.S. Ser. No. 62/142,616, provisionally filed on Apr. 3, 2015, entitled “METHOD AND SYSTEM FOR PATIENT IDENTIFICATION WHEN OBTAINING MEDICAL IMAGES”, in the names of Shreiber et al, which is incorporated herein by reference in its entirety.

### FIELD OF THE INVENTION

The present invention relates to a system and method for patient identification when obtaining medical images and particularly, but not exclusively, to incorporating automatic patient identification in a Radiology Information System (RIS).

### BACKGROUND OF THE INVENTION

Medical imaging has become an increasingly important diagnostic tool, allowing skilled medical personnel, such as doctors, to obtain images of inner body organs and tissues. A variety of medical imaging technologies and modalities are available, including but not limited to CT (computerized tomography) scans, MRI (magnetic resonance imaging) scans, PET (positron emission tomography) scans, radiology (x-ray) scans, mammography scans and the like. These tools are very important to physicians and so are often operated according to a very tight schedule, thereby increasing the possibility of errors.

One particularly pernicious error is mistaken identification of the patient. Without correct identification, a number of further errors can occur. For example, the incorrect tool and/or image process may be performed on the patient. As another example, the correct tool and image process may be applied, but if the images are then associated with an incorrect patient name or other identifier, the physician will not be able to perform the correct diagnosis.

### SUMMARY OF THE INVENTION

The disclosure relates to a system and method for patient identification when obtaining medical images, optionally and preferably by incorporating automatic patient identification in an image information system, in a manner which is directly tied to the screening modality. By “patient” it is meant any subject undergoing a medical procedure to obtain medical images. The image information system is preferably any DICOM compliant imaging system, or at least DICOM compliant to the extent necessary to interact with DICOM systems and/or to work with a modality worklist, including but not limited to a RIS (Radiology Information System), a HIS (hospital information system) or an EMR (electronic medical record).

The medical procedure typically involves a screening modality, in which images are obtained by a screening device used for the screening modality, operated in the correct manner (according to a prescription from a doctor or other medical personnel).

Various examples of being “directly tied” include but are not limited to identification of the patient in a physically proximate location to the screening device being used for the screening modality; and/or selection and/or performance of a screening procedure to be performed with the screening modality according to identification of the patient.

Non-limiting examples of such a physically proximate location include being in the same room as the screening modality or at least being in a location, sufficiently near the tool, that clearly the correct patient is being selected for the medical imaging procedure. In order to determine physical proximity (and/or as a substitute for determining physical proximity), optionally one or more mechanisms may be employed, including but not limited to identifying the patient within a specific time period, including but not limited to less than 1 minute, less than 5 minutes, less than 10 minutes, less than 15, 20, 25 or 30 minutes, before a procedure is performed (or any time period in between), such that this time-limited identification is required before any medical imaging process is selected and/or started; or identifying the patient through a device that is within a certain distance of the screening modality. Such a device may optionally be connected to the modality or alternatively may have a limited range such that it cannot be farther than 1 foot, 2 feet, 3 feet or any of 4-25 feet from the screening modality. Optionally the device may be considered to be part of the screening modality or else it can be a separate device.

Without wishing to be limited by a closed list, such automatic patient identification is preferably able to support application of the screening device and image process for the screening modality, followed by correct association of the subsequent images with a correct patient name or other identifier.

By “correct screening device” or “correct imaging tool” it is meant the correct imaging technology which has been ordered by medically skilled personnel, such as a physician. Any suitable imaging technology may optionally be applied, CT (computerized tomography) scans, MRI (magnetic resonance imaging) scans, PET (positron emission tomography) scans, radiology (x-ray) scans, mammography scans and the like.

By “correct image process” it is meant the parameter(s) for operating the imaging tool in order to obtain the desired image(s) as ordered by medically skilled personnel, such as a physician. Optionally the term “correct image process” includes imaging the correct body part, area or organ, such that the parameter(s) may optionally include such a correct body part, area or organ. Optionally, the parameters may also include administration of any necessary additional material, such as contrast agent, radioactive material and the like; and/or selection of the correct imaging protocol.

The patient identifier may optionally comprise a patient name (for example, given name and surname), an alphanumeric identification string or other non-patient name identification string, and the like.

The term “user” is used herein interchangeably with the terms “technician”, “radiographer”, “doctor”, “physician”, “radiologist” and the like. All such terms may be understood to refer generally to any user; no limitation is made on the role of the individual who is the user of the various embodiments of the present invention as described herein.

Although the present description relates to interactions with medical image data, it is understood that the present invention may optionally be applied to any suitable image data, including but not limited to computer games, graphics, artificial vision, computer animation, biological modeling (including without limitation tumor modeling) and the like.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 is an illustrative, exemplary system for obtaining medical images with correct patient identification according to at least some embodiments of the present invention; and

FIG. 2 shows an exemplary method for obtaining medical images with correct patient identification according to at least some embodiments of the present invention.

### DESCRIPTION OF SOME EMBODIMENTS OF THE INVENTION

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a tablet, a PDA (personal digital assistant), or a pager. Any two or more of such devices in communication with each other may optionally comprise a “computer network”.

At least some embodiments of the present invention are now described with regard to the following illustrations and accompanying description, which are not intended to be limiting in any way.

As noted previously, according to at least some embodiments, there is provided a system and method for patient identification when obtaining medical images, optionally and preferably by incorporating automatic patient identification in an imaging information system, of which a Radiology Information System (RIS) is given as a non-limiting example, in a manner which is directly tied to the screening modality. Various examples were given herein for tying the identification to the screening modality, which has a number of advantages. Without wishing to be limited to a closed list, these advantages include identifying the patient in a way which, for example, ensures physical proximity to the screening modality; and/or ensuring that the screening modality receives a worklist with only one name in it, such that there is no error of selection of the modality worklist.

A modality worklist is a DICOM object, created according to the DICOM standard. It includes a description of one or more procedures to be performed with the imaging tool or device on one or more specific patients, determined according to a prescription given by a doctor or other medical personnel for each such specific patient.

Again without wishing to be limited by a closed list, various undesirable scenarios are eliminated, including for example the problem of having the technician/screening modality operator call to a patient but the wrong patient enters the room (whether due to an error in the name, mispronunciation, multiple patients with the same name, a misheard name or so forth); the correct patient enters the screening modality room but then the technician selects the wrong patient from the list; a patient that is not on the list enters to the MRI scanning room without being processed for safety issues (for example, as part of this processing for an MRI, the patient is typically checked for metal before entering the magnet due to problems with the presence of metal).

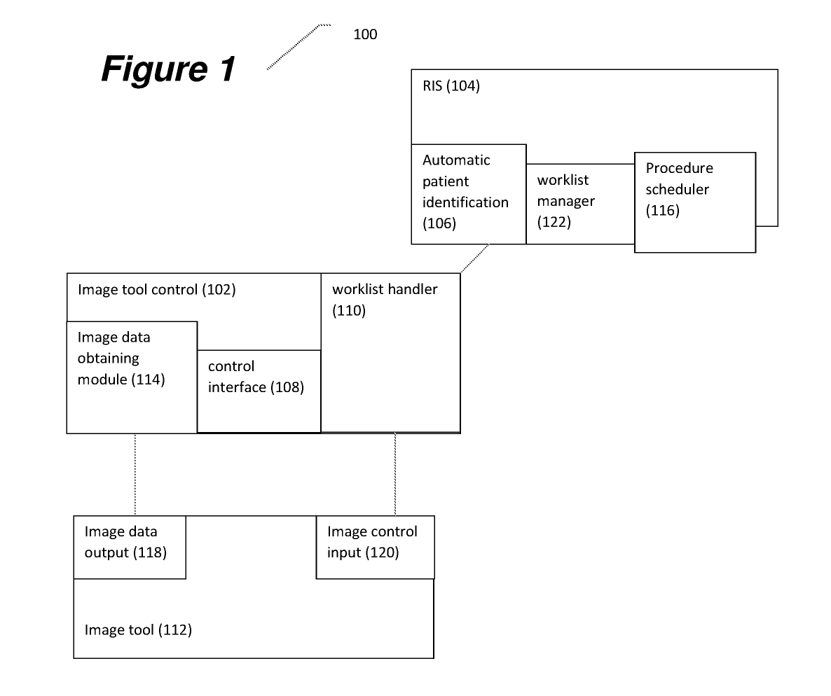

FIG. 1 is an illustrative, exemplary system for obtaining medical images with correct patient identification according to at least some embodiments of the present invention. A system 100, as shown, features an image tool control 102 for controlling the operation of an image tool 112, which obtains image data from a subject (referred to interchangeably as a “patient”). As described herein, image tool 112 may optionally use any suitable imaging technology. Image tool control 102 is preferably DICOM compliant, in order for modality worklists to be used.

In order for image tool control 102 to control the operation of image tool 112 such that the proper medical procedure is performed on the subject, image tool control 102 receives a modality worklist from an image information system, of which a non-limiting example is a Radiology Information System (RIS) 104.

A doctor or other medical personnel sends the prescription for the specific imaging, which is used to create the entry on the modality worklist for that specific patient. According to the DICOM standard, the modality worklist could have medical imaging procedure information for multiple patients, indicating the procedure to be performed (for example, the image process to be performed, the body part(s) or locations of the body to be imaged, any particular parameters specified for the imaging process by the doctor, and so forth).

The modality worklist determines the operation of image tool 112 as controlled by image tool control 102. As shown in the exemplary configuration in FIG. 1, the worklist is created and managed by a worklist manager 122. The worklist (and/or each entry on the worklist) may optionally be created automatically, directly from input from the doctor, or alternatively may be created manually, by a human RIS operator entering the prescription to RIS 104.

Scheduling of procedures is also preferably performed through RIS 104, whether automatically or manually, through a procedure scheduler 116. If automatically, procedure scheduler 116 would determine the next available timeslot for the subject to undergo the imaging procedure, optionally also weighing the urgency of a particular subject's need for imaging. If manually, a human operator would determine the time of the procedure through procedure scheduler 116.

Regardless of how the modality worklist is entered or the procedure is scheduled, when the time comes for the subject to undergo the imaging procedure, optionally and preferably the process is as follows.

Preferably, as described in greater detail below, the patient has an identification device, such as a barcode tag for example, that is fixed. By “fixed” it is meant that the patient identification device is clearly associated with a particular patient, for example by being attached to the patient's body or garment. Such a fixed identification device enables the patient to be correctly identified by a patient identification module 106, for example by scanning or otherwise interacting with the patient identification device. Patient identification module 106 is preferably part of RIS 104. Such scanning or interacting preferably occurs in close physical proximity to image tool 112, for example in the same room as image tool 112. A non-limiting fixed identification device is a band attached to their wrist (part of the regular procedure in many hospitals today). Other types of fixed identification devices could also optionally be used, as could other methods for identifying the patient from the fixed identification device by patient identification module 106. Optionally a part of the patient's body is used as the fixed identification device, such as a fingerprint, palmprint, retinal scan and the like.

Once the patient has been identified, RIS 104 generates a worklist with a single entry, for that patient, to a worklist handler 110 at image tool control 102. Previously, RIS 104 would provide a worklist with all upcoming procedures to image tool control 102, or at least such upcoming procedures would be accessible through image tool control 102. Such availability permitted errors of patient identification to occur quite easily.

In contrast, as shown in FIG. 1, worklist handler 110 now receives a worklist with a single entry for that specific patient. Alternatively, even if worklist handler 110 receives multiple such entries, RIS 104 instructs image tool control 102 to only provide or enable a single such entry on the worklist. If an element of human control is desired, rather than automatically implementing the single entry on the worklist by image tool control 102, the worklist (with a single entry) can be first displayed to the human operator for selection through a control interface 108. Control interface 108 also optionally and preferably controls other aspects of the operation of image tool control 102.

Image tool 112 then obtains the image data of the patient by an image control input module 120, which is then output by an image data output module 118 to an image data obtaining module 114. The image data is associated with the patient identification in image data obtaining module 114, thereby preventing this source of medical error.

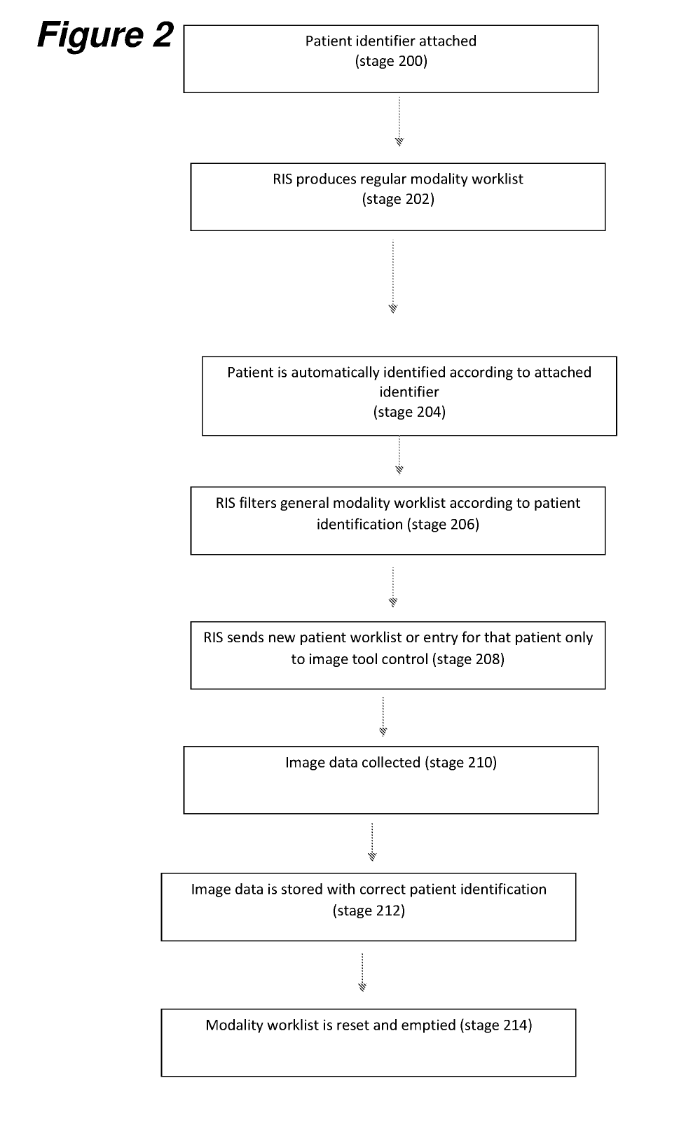

FIG. 2 shows an exemplary method for obtaining medical images with correct patient identification according to at least some embodiments of the present invention. As shown, in stage 200, a patient has an identification barcode tag attached to their wrist (part of the regular procedure in many hospitals today) as a non-limiting example of the fixed identification device. Of course, as previously described, other types of patient identification could be used, preferably by attachment to the patient. For outpatient scenarios, the receptionist or other outpatient worker may optionally use the RIS (Radiology Information System) to produce such a tag and may then attach it to the patient's wrist.

In stage 202, the RIS produces the regular modality worklists and will supply it to each image tool control. The modality worklist is a list of the patients with their demographic information to be included in the studies to be selected by the user, along with the procedure code for determining which procedure is to be performed. This list is the product of all orders for the particular modality (that is, device for obtaining medical images or image tool) that were generated in the RIS that are waiting to be executed on that particular date.

In stage 204, when the patient enters the examination room or otherwise becomes in close physical proximity to the image tool, but before the image data collection begins, the identity of the patient is determined either by the technician or other image tool worker that scans the tag that is attached to the patient's wrist using a barcode reader or electronically by RFID or by any other suitable automatic identification means. This method identifies the patient and the equipment/room that is used and sends the information to the RIS. The scanner may optionally be part of the RIS or directly connected to the RIS.

In stage 206, RIS filters the general modality worklist by the name of the patient present in the room. If the patient is not on the modality worklist, then the RIS notifies the technician of the discrepancy.

In stage 208, the RIS generates to the image tool control a new patient worklist consisting of a single entry for that patient only; alternatively the RIS could permit the image tool control to display only a single entry from the worklist. Thus the technician cannot select the wrong patient for any reason, since there is only a single patient on the worklist or at least there is only a single entry from the worklist that is displayed. Alternatively, even if more than one entry, or even all entries, are displayed, the technician preferably cannot take action to invoke any entry for activating the image tool control except for the entry designated by the RIS as belonging to the identified patient.

In stage 210, examination is performed by the image tool, in terms of collecting image data. Examination may optionally be executed automatically, or alternatively optionally the image tool worker (technician) may have the single entry displayed and must then select this entry in order for examination to be performed.

In stage 212, once completed, the image data is stored in association with the correct patient identification.

In stage 214, the modality worklist on the image tool control is preferably reset and emptied. Alternatively, preferably no other entries on the modality worklist are available for performance through the image tool control as previously described, even if the worklist isn't emptied. For any new patient that enters the room, the technician preferably must scan the tag attached to that patient's wrist or otherwise obtain the correct patient identification as described above.

Accordingly, there is described a method for identification of a patient for medical imaging, comprising: identifying the patient according to a fixed identifier before medical imaging data is obtained; automatically selecting a medical imaging process according to the identifying the patient by a medical imaging process controller; performing the medical imaging process on the patient; and associating image data obtained from the performing the medical imaging process with a patient identity determined by the identifying the patient.

The medical imaging process comprises a medical imaging tool and at least one action to be performed with the medical imaging tool. The fixed identifier comprises a device attached to the patient, and wherein the identifying the patient comprises bringing the patient in physical proximity to the medical imaging tool and interacting with the device attached to the patient to identify the patient. Physical proximity to the medical imaging tool comprises having the patient in a room with the medical imaging tool. Physical proximity to the medical imaging tool comprises having the patient in a room adjacent to the medical imaging tool.

There is described a system for identification of a patient for medical imaging, comprising: an image tool for obtaining medical imaging data and an image tool controller for controlling the image tool, wherein the image tool controller further comprises an image action selector for selecting one or more actions to be performed with the image tool and a patient identification module for automatically identifying the patient according to a fixed patient identifier; wherein upon identifying the patient, the image action selector only provides actions related to the patient.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for identification of a patient for medical imaging, comprising:
identifying the patient according to a fixed identifier before medical imaging data is obtained;
automatically selecting a medical imaging process according to the identifying the patient by a medical imaging process controller;
performing the medical imaging process on the patient; and
associating image data obtained from the performing the medical imaging process with a patient identity determined by the identifying the patient.

2. The method of claim 1, wherein the medical imaging process comprises a medical imaging tool and at least one action to be performed with the medical imaging tool.

3. The method of claim 2, wherein the fixed identifier comprises a device attached to the patient, and wherein the identifying the patient comprises bringing the patient in physical proximity to the medical imaging tool and interacting with the device attached to the patient to identify the patient.

4. The method of claim 3, wherein physical proximity to the medical imaging tool comprises having the patient in a room with the medical imaging tool.

5. The method of claim 3, wherein physical proximity to the medical imaging tool comprises having the patient in a room adjacent to the medical imaging tool.

6. A system for identification of a patient for medical imaging, comprising: an image tool for obtaining medical imaging data and an image tool controller for controlling the image tool, wherein the image tool controller further comprises an image action selector for selecting one or more actions to be performed with the image tool and a patient identification module for automatically identifying the patient according to a fixed patient identifier; wherein upon identifying the patient, the image action selector only provides actions related to the patient.
